(19) United States
(12) Patent Application Publication
(10) Pub. No.: US 2009/0065295 A1
(43) Pub. Date: Mar. 12, 2009

(54) DESUPERHEATER MUFFLER

(76) Inventors: Sanjay V. Sherikar, Mission Viejo, CA (US); Michael J. Weathers, El Paso, TX (US)

Correspondence Address: STETINA BRUNDA GARRED & BRUCKER, 75 ENTERPRISE, SUITE 250, ALISO VIEJO, CA, 92656, US

(21) Appl. No.: 11/853,422

(22) Filed: Sep. 11, 2007

(51) Int. Cl. F16L 55/02

(52) U.S. Cl. 181/233

(57) ABSTRACT

A liner system for a steam outlet pipe of a turbine bypass system comprises a liner mounted in spaced coaxial relation to the inner pipe wall such that an annular cavity is defined between the liner and the steam outlet pipe. The cavity is open on an upstream end and closed on a downstream end such that a quarter-wavelength resonator is formed for attenuating noise associated with a flow of superheated steam passing through the steam pipe. The liner may include a plurality of perforations to further attenuate noise in the steam outlet pipe. The open upstream end and closed downstream end of the cavity increases pressure within the cavity to prevent cooling water from entering the perforations and contacting the inner pipe wall. A wire mesh disposed against the outer liner wall may block cooling water penetration through the perforations and may further attenuate noise associated with the flow of superheated steam.

### CROSS-REFERENCE TO RELATED APPLICATIONS

### (Not Applicable)

### STATEMENT RE: FEDERALLY SPONSORED RESEARCH/DEVELOPMENT

### (Not Applicable)

### BACKGROUND

The present invention relates generally to steam desuperheaters and, more particularly, to a liner which is mountable within the interior of a steam pipe and which is specifically adapted to attenuate or reduce noise associated with a flow of superheated steam in the steam pipe while preventing damage to the steam pipe as a result of cold spray water impinging upon the hot inner surface of the steam pipe wall. The liner may further be configured to create a venturi effect within the steam pipe in order to increase the velocity of the steam relative to the cold spray water and thereby enhance evaporation of the spray water within the steam flow.

Many industrial facilities operate with superheated steam that has a higher temperature than its saturation temperature at a given pressure. Because superheated steam can damage turbines or other downstream components, it is necessary to control the temperature of the steam. Desuperheating refers to the process of reducing the temperature of the superheated steam to a lower temperature, permitting operation of the system as intended, ensuring system protection, and correcting for unintentional amounts of superheat.

A steam desuperheater can lower the temperature of superheated steam by spraying cooling water into the flow of superheated steam passing through a steam pipe. Once the cooling water is sprayed into the flow of superheated steam, the cooling water mixes with the superheated steam and evaporates, drawing thermal energy from the steam and lowering its temperature. If the cooling water is sprayed into the superheated steam pipe in a streaming pattern, the spray of cooling water may impinge on the hot inner wall of the steam pipe resulting in the creation of thermal stresses and erosion in the steam pipe which, over time, may lead to structural failure.

Various desuperheater devices have been developed to overcome the above-mentioned problem. One such prior art desuperheater device is configured to spray cooling water into the steam pipe at an angle to avoid impingement of the cooling water against the hot inner walls of the steam pipe. However, the construction of this device is complex and includes many parts such that the device has a high construction and assembly cost.

Another prior art desuperheater device utilizes a spray tube positioned in the center of the steam pipe with multiple nozzles and a moving plug or slide member adapted to uncover an increasing number of nozzles. Each of the nozzles is in fluid communication with a cooling water source to spray cooling water into the center of the steam pipe. Unfortunately, this device is also necessarily complex, costly to manufacture and install, and requiring a high degree of maintenance after installation.

Another problem associated with steam desuperheaters is noise control. More specifically, noise that is associated with or that is generated by superheated steam flowing through a steam pipe can reach relatively high levels. In order to comply with various federal, state and local noise regulations, it is typically necessary to muffle or reduce such noise levels. For example, prior to venting any overpressure in a steam flow to atmosphere, various types of vent silencers and diffusers may be employed in conjunction with safety valves to reduce the total noise output. Such vent silencers and diffusers are typically installed as downstream components and are therefore generally ineffective in reducing noise associated with or generated by the flow of superheated steam.

As may be appreciated, there exists a need in the art for a system which provides the combined capability of attenuating noise associated with a superheated steam flowing through a steam pipe while simultaneously preventing impingement of cooling water spray of a desuperheater against the hot inner pipe wall. Furthermore, there exists a need in the art for such a system which is also capable of enhancing the evaporation of the cooling water spray within the flow of superheated steam. Finally, there exists a need for a system providing the aforementioned capabilities and which is of simple construction and which requires little or no maintenance.

### BRIEF SUMMARY

The present invention specifically addresses and alleviates the above-referenced deficiencies associated with steam desuperheaters of the prior art. More particularly, the present invention provides a liner system that may be adapted for mounting within a steam outlet pipe of a turbine bypass system. The liner system is configured to attenuate noise associated with a flow of superheated steam passing through the steam pipe and is further configured to prevent direct impingement of cooling water spray against the hot inner pipe wall of the steam pipe. At least one nozzle assembly may be mounted on the steam pipe in order to provide the spray of cooling water into the flow of superheated steam to reduce the temperature thereof.

The liner system comprises a liner which is sized and configured to be positioned adjacent to an inner pipe wall of at least a portion of the steam outlet pipe in order to form a quarter-wavelength resonator cavity between an outer liner wall and the inner pipe wall for attenuating noise associated with the superheated steam flow. As mentioned above, the liner also prevents impingement of cooling water spray upon the inner pipe wall in order to reduce or prevent thermal shock to the steam pipe and any associated components.

The liner may further be configured to create a venturi effect within the flow of superheated steam to locally increase the velocity of the superheated steam flowing through the steam pipe and thereby enhance evaporation of the cooling water spray to improve cooling of the superheated steam. The liner is preferably coaxially mounted within the steam outlet pipe such that the cavity formed between an outer liner wall of the liner and the inner pipe wall of the steam pipe is annular in shape.

The cavity is preferably open on an upstream end of the steam pipe such that the cavity faces the oncoming flow of superheated steam. A downstream end of the cavity is preferably closed to form the quarter-wavelength cavity. The open upstream end of the cavity generate a pressure increase within the cavity relative to the pressure in the main flow of superheated steam.

The liner may include a plurality of spaced perforations which preferably extend radially through a thickness of the liner. The cavity as well as the perforations are preferably sized and configured to promote the flow of superheated steam into the open end of the cavity such that the superheated steam entering the cavity is forced radially inwardly through the perforations into the main flow of superheated steam in order to enhance acoustic attenuation thereof. The flow of superheated steam through the perforations may also promote the venturi effect within the flow of superheated steam to enhance evaporation of the cooling water.

The inwardly directed flow of superheated steam through the perforations may further block the flow of cooling water into the perforations as well as increase turbulence in the main flow of steam passing through the steam pipe to enhance evaporation of cooling water. The perforations are preferably sized and configured to attenuate noise occurring within the steam outlet pipe. For perforated embodiments of the liner, porous material such as a wire mesh may be mounted within the cavity to prevent cooling water from flowing through the perforations toward the hot inner pipe wall and to enhance the acoustic effects of the annular cavity.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is longitudinal sectional view of a prior art liner system installed within a steam pipe of a desuperheating device wherein the liner is disposed in contacting relation to the steam pipe;

FIG. 2A is a longitudinal sectional view of the desuperheating device illustrating the liner system of the present invention wherein the liner is disposed in spaced relation to the steam pipe and defining an annular cavity open on an upstream end thereof and closed on a downstream end; and

FIG. 2B is a longitudinal sectional view of the desuperheating device illustrating the liner system in a further embodiment including a plurality of perforations formed in the liner and further illustrating a wire mesh installed against an outer liner wall of the liner.

### DETAILED DESCRIPTION

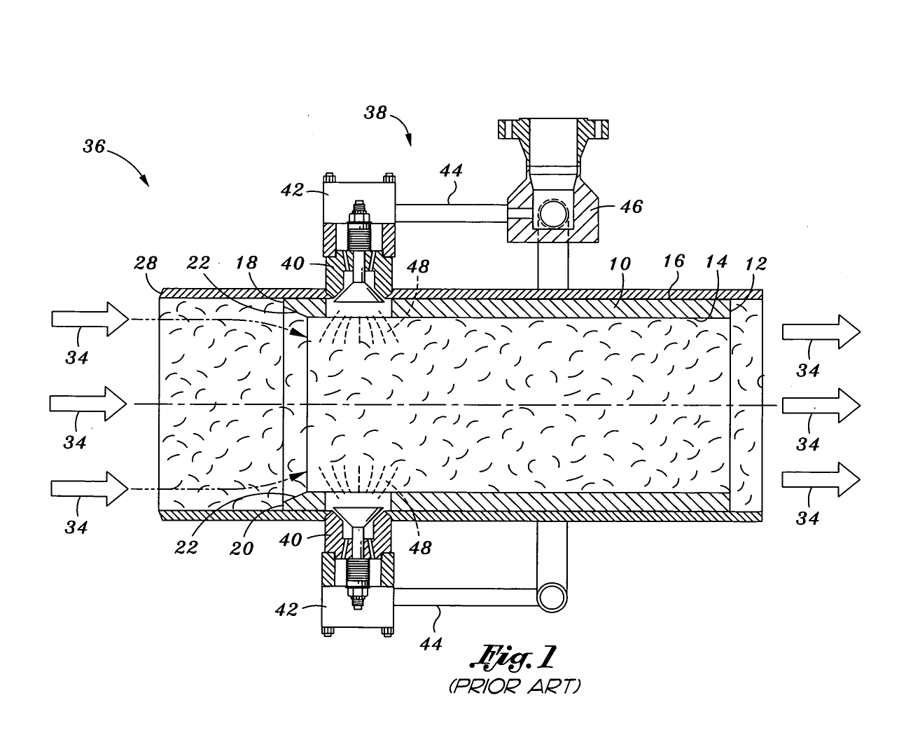

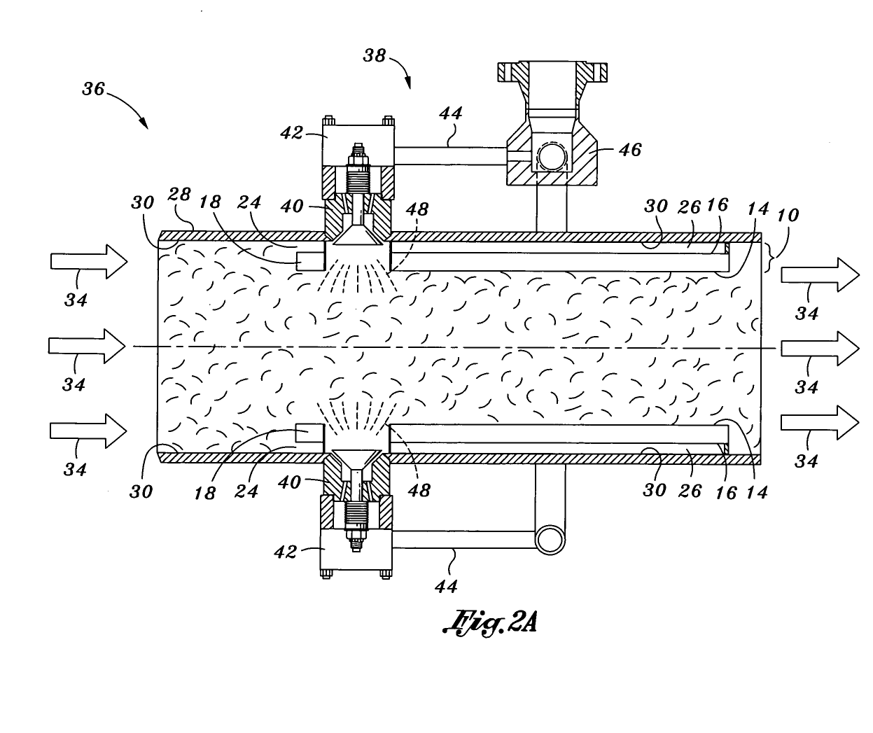

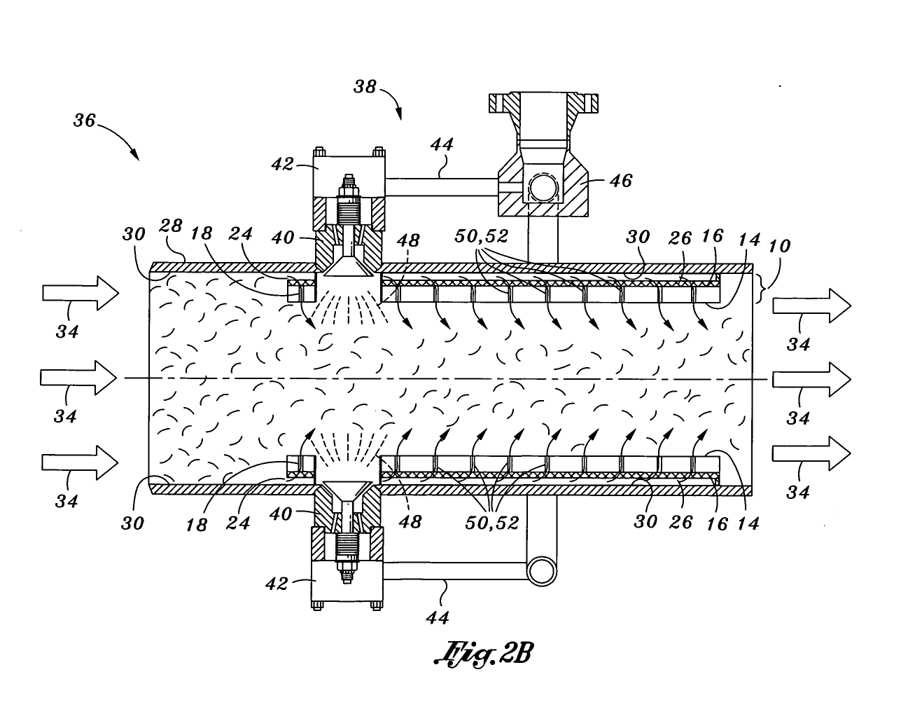

Referring now to the drawings wherein the showings are for purposes of illustrating preferred embodiments of the present of the invention and not for purposes of limiting the same, shown in the figures are longitudinal sectional views of a desuperheating device 38 incorporating a liner system 10. A prior art version of the liner system 10 is shown in FIG. 1 which illustrates a liner 14 wherein an outer liner wall 16 thereof is disposed in abutting contact with an inner pipe wall 30 of a steam pipe 28 of the desuperheating device 38. In contrast, FIGS. 2A-2B illustrate a liner system 10 of the present invention wherein the liner 12 is disposed in spaced relation to the inner pipe wall 30 such that an annular resonator cavity 24 is formed between the liner 12 and the steam pipe 28 for attenuating noise associated with a flow of superheated steam 34 passing through the steam pipe 28, as will be described in greater detail below.

The desuperheating device 38 may be constructed similar to that which is utilized in turbine bypass systems 36. As can be seen in the figures, the desuperheating device 38 may include a nozzle assembly 40 mounted on the steam pipe 28. The nozzle assembly 40 may be adapted to provide a spray of cooling water 48 into the interior of the steam pipe 28 for dispersion into the flow of superheated steam 34 passing through the steam pipe 28. The nozzle assembly 40 shown in FIG. 1 may be constructed similar to that which is disclosed in commonly-owned U.S. Pat. No. 6,746,001, the entire contents of which is expressly incorporated by reference herein.

As mentioned above, the liner system 10 shown in FIGS. 2A-2B is specifically adapted to attenuate acoustic energy or noise such as valve noise that may be associated with the flow of superheated steam 34 passing through the steam pipe 28. The annular cavity 24 formed between the liner 12 and the steam pipe is preferably open on an upstream end 18 of the cavity and closed on a downstream end thereof such that the cavity 24 is sized and configured as a quarter-wavelength resonator cavity.

The frequency or frequency band of the noise which the quarter-wavelength annular cavity 24 is configured to attenuate is proportional to the length of the annular cavity 24. Furthermore, although the quarter-wavelength resonator cavity 24 is provided with a substantially constant and linear cross sectional shape as shown in the figures, it is contemplated that the cavity 24 may be configured in any configuration providing noise cancellation of the desired frequency spectrum. For example, the cavity 24 may be formed in any curved and/or three-dimensionally varying shape. However, due to a desire to simplify manufacturing, installation and ease of tunability to a given frequency band, the liner 12 is preferably configured such that the cavity 24 is formed as a linear, elongate annular cavity 24 that is concentrically mounted relative to the inner pipe wall 30 and is preferably of substantially uniform cross section along its length.

In addition to the above-mentioned noise attenuation characteristics, the liner system 10 may further be configured to provide protection to a pressure boundary 32 located along the inner pipe wall 30 of the steam pipe 28. As is known in the art, the pressure boundary 32 of the inner pipe wall 30 of a desuperheating device 38 is typically heated to at an elevated temperature due to the constant flow of superheated steam 34 through the steam pipe 28. The liner 12 covers at least a portion of a length of the inner pipe wall 30. The liner 12 prevents damage to the steam pipe 28 as a result of thermal shock which would otherwise occur at the hot inner pipe wall 30 as a result of contact with cooling water spray from the desuperheating device 38. The liner 12 may be provided in several embodiments which are illustrated in FIGS. 2A and 2B and which are described in greater detail below.

As can be seen in each of the figures, a flow of superheated steam 34 enters the steam pipe 28 at a relatively high velocity and passes by the nozzle assembly 40. The nozzle assembly 40 is comprised of at least one spray nozzle which may be mounted to the steam pipe 28 by welding or other suitable means. A nozzle holder 42 is connected to a cooling water feedline 44. The cooling water feedline 44 is connected to a cooling water control valve 46 which, in turn, is fluidly connected to a suitable high pressure water supply (not shown). The control valve 46 regulates the flow of cooling water into the cooling water feedline 44 in response to a signal from a temperature sensor (not shown) mounted in an interior of the steam pipe 28 downstream of the nozzle assembly 40.

Although the figures illustrate a pair of diametrically-opposed nozzle assemblies 40 mounted to the steam pipe 28, any number may be provided. When moved to the open position, the nozzle assembly 40 provides a spray of cooling water into the interior of the steam pipe 28 in order to reduce the temperature of the superheated steam 34 as a result of evaporation of the cooling water spray 48 with the steam flow 34.

As can be seen in FIGS. 2A and 2B, the liner 12 is specifically adapted to be mounted within the steam pipe 28 and is configured to be disposed in spaced relation to the steam pipe 28. As mentioned above, the liner 12 is sized and configured to and cover at least a portion of a length of the inner pipe wall 30. Although the liner 12 is preferably provided in a cylindrical configuration, the liner 12 may be provided in any number of alternative configurations.

In each configuration, the liner 12 is preferably sized and configured so as to be complementary in size and shape to the inner pipe wall 30. For example, the liner 12 is preferably provided in a cylindrically shaped configuration so as to be complementary to a cylindrically shaped inner pipe wall 14. The liner 12 includes an upstream end 18 preferably located upstream of the nozzle assembly 40 and a downstream end located downstream of the nozzle assembly 40. The upstream end 18 of the liner 12 generally faces or is oriented toward the oncoming flow of superheated steam 34 passing through the steam pipe 28.

As can be seen in FIG. 1, the liner 12 may further be configured to generate a venturi effect within the flow of superheated steam 34 passing through the steam pipe 28. The venturi effect is manifested as an increase in the velocity of the steam 34 downstream of the upstream end 18. The increase in velocity of the superheated steam 34 increases mixing of the cooling water spray 48 with the steam flow 34 and thereby enhances evaporation of the cooling water spray 48 and a reduction in the temperature of the steam flow 34.

Similar to the chamfered edge 20 configuration at the upstream end 18 of the prior art liner 12 configuration of FIG. 1, the liner system 10 of FIGS. 2A and 2B may likewise be provided with a chamfered edge 20 configuration at the upstream end 18 to generate the venturi effect. The venturi effect may also assist in reducing noise that would otherwise be generated at that location by a non-chamfered edge configuration. As was earlier mentioned, the venturi effect results in an increase in the velocity of the steam 34 and promotes dispersion and evaporation of the cooling water spray 48 within the steam flow 34. The edge 20 configuration shown in the prior art liner 12 of FIG. 1 also preferably enhances the flow profile of the superheated steam 34 through the steam pipe 28.

In a further embodiment shown in FIG. 2B, the liner 12 may be provided with a plurality of perforations 50 extending through at least a portion of a thickness of the liner 12. In addition to allowing higher pressure steam within the cavity 24 to flow passing radially inwardly through the perforations 50, the perforations 50 may also be sized and configured to enhance noise attenuation within the flow of superheated steam. The degree to which the perforations 50 contribute toward noise attenuation is dictated in part by the sizing of the perforations 50. Noise attenuation characteristics are also controlled to some degree by the shape (e.g., cylindrical), size (e.g., diameter), length (e.g., radial depth) and spacing (e.g., center-to-center distance) of the perforations 50.

As was earlier mentioned, the annular cavity 24 is open at the upstream end 18 such that a slight pressure differential is created on radially opposite sides (i.e., inner and outer liner walls 14, 16) of the liner 12. The pressure differential induces a portion of the steam flow 34 entering the cavity 24 to pass radially inwardly through the perforations 50 whereafter the superheated steam rejoins the main flow of superheated steam 34. The radially inwardly-directed flow of steam through the perforations 50 serves to block or expel cooling water which would otherwise pass through the perforations 50 and contact the hot inner pipe wall 30.

The specific sizing of the cavity 24 opening at the upstream end 18 is preferably such that a sufficient amount of superheated steam 34 flows into the cavity 24 in order to resist cooling water penetration through the perforations 50. Furthermore, the sizing of the cavity 24 and the configuration of the perforations 50 preferably enhances evaporation of the cooling water spray 48 with the superheated steam 34 by increasing turbulence in the flow of superheated steam 34 which, in turn, enhances cooling water evaporation.

In a further embodiment illustrated in FIG. 2B, the annular cavity 24 defined between the liner 12 and the steam pipe 28 may be at least partially filled with a sound-absorbing material such as a porous material 52 such as wire mesh 26 or other suitable porous materials 52. The porous material 52 may be configured as an essentially tubular element that is wrapped around or which circumscribes the outer liner wall 16 of the liner 12. The porous material 52 may be provided in a thickness that maintains the annular cavity 24 between the porous material 52 and the inner pipe wall 30 such that the cavity 24 acts as a resonator for noise attenuation purposes.

In addition, the porous material 52 may be configured to prevent cooling water from passing through the perforations 50 and contacting the inner pipe wall 30. Ideally, the sizing (i.e., thickness) and configuration of the porous material 52 is optimized to provide a balance between the capability of the liner 12 to generate the venturi effect and the contribution of the porous material 52 in resisting the radially-inwardly directed movement of cooling water through the perforations 50 toward the hot inner pipe wall 30.

As with the perforations 50 in the liner 12, attenuation characteristics of the porous material 52 is a function of the orientation and configuration (e.g., size) of the individual elements which make up the porous material 52 as well as the relative orientation of such individual elements. In addition, the geometry of the annular cavity 24 between the inner pipe wall 30 and the outer liner wall 16 may be optimized in conjunction with the perforation 50 size and spacing in order to achieve a balance of venturi effect, noise attenuation, enhanced mixing of the cooling water, and protection of the inner pipe wall 30 against impingement by the cooling water spray 48.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A liner system for a steam pipe having an inner pipe wall for containing a flow of superheated steam, the liner system comprising:
a liner adapted to be mounted within the steam pipe and being configured to be disposed in spaced relation to at least a portion of the inner pipe wall such that an annular cavity is formed between the liner and the steam pipe;
wherein:
the liner includes an upstream end and a downstream end;
the cavity being open on the upstream end and closed on the downstream end such that the cavity forms a resonator for attenuating noise associated with the flow of superheated steam.

2. The liner system of claim 1 wherein the liner is sized and configured such that the cavity forms a quarter-wavelength resonator.

3. The liner system of claim 1 wherein the liner is disposed in spaced coaxial relation to the inner pipe wall.

4. The liner system of claim 1 wherein the liner includes a plurality of perforations.

5. The liner system of claim 4 wherein the perforations are radially oriented and extend through at least a portion of a thickness of the liner.

6. The liner system of claim 4 wherein the perforations are sized and configured to attenuate noise associated with the flow of superheated steam through the steam pipe.

7. The liner system of claim 1 further including porous material disposed within the cavity, the porous material being positioned in spaced relation to the inner pipe wall such that the cavity is formed between the porous material and the steam pipe.

8. The liner system of claim 7 wherein the porous material is wire mesh.

9. The liner system of claim 7 wherein the porous material is sized and configured to prevent superheated steam from passing radially outwardly through the perforations.

10. The liner system of claim 7 wherein the porous material is sized and configured to attenuate noise associated with the flow of superheated steam.

11. The liner system of claim 1 wherein the upstream end is configured to generate a venturi effect within the flow of superheated steam.

12. The liner system of claim 11 wherein the upstream end has a chamfered circumferential edge.

13. A steam outlet pipe for a turbine bypass system, the steam outlet pipe having an inner pipe wall and being adapted to contain a flow of steam passing therethrough and further including at least one nozzle assembly mounted thereon for spraying cooling water into the flow of steam, the steam outlet pipe comprising:
a liner disposed in spaced coaxial relation to the inner pipe wall such that an annular cavity is defined between the liner and the steam outlet pipe, the cavity being open on an upstream end and closed on a downstream end such that the cavity forms a resonator for attenuating noise associated with the flow of superheated steam.

14. The liner system of claim 13 wherein the liner is sized and configured such that the cavity forms a quarter-wavelength resonator.

15. The liner system of claim 13 wherein the liner is disposed in spaced coaxial relation to the inner pipe wall.

16. The liner system of claim 13 wherein the liner includes a plurality of radially oriented perforations extending through at least a portion of a thickness of the liner.

17. The liner system of claim 16 wherein the perforations are sized and configured to attenuate noise associated with the flow of superheated steam through the steam pipe.

18. The liner system of claim 13 further including porous material disposed within the cavity, the porous material being positioned in spaced relation to the inner pipe wall such that the cavity is formed between the porous material and the steam pipe.

19. The liner system of claim 18 wherein the porous material is sized and configured to prevent superheated steam from passing radially outwardly through the perforations.

20. The liner system of claim 18 wherein the porous material is sized and configured to attenuate noise associated with the flow of superheated steam.
